(19) United States
(12) Patent Application Publication
(10) Pub. No.: US 2008/0199758 A1
(43) Pub. Date: Aug. 21, 2008

(54) SMALL PORTABLE FUEL CELL AND MEMBRANE ELECTRODE ASSEMBLY USED THEREIN

(76) Inventors: Seung-shik SHIN, Suwon-si (KR); Ho-jin KWEON, Suwon-si (KR); Mee-young LEE, Suwon-si (KR); Tae-keun KIM, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/956,180

(22) Filed: Dec. 13, 2007

(30) Foreign Application Priority Data
Feb. 15, 2007 (KR) 10-2007-0016197

(51) Int. Cl. H01M 4/92

(52) U.S. Cl. 429/34; 429/40; 977/742

(57) ABSTRACT

A fuel cell includes: a fuel cell body; and a fuel supplier supplying fuel to the fuel cell body, wherein the fuel cell body includes: a membrane electrode assembly including an ion exchange membrane, an anode catalyst layer positioned at one surface of the ion exchange membrane, an anode gas diffusion layer positioned at one surface of the anode catalyst layer, and a cathode catalyst layer positioned at other surface of the ion exchange membrane; and a fuel flow field positioned at the one surface of the anode gas diffusion layer and supplying the fuel to the anode catalyst layer through the anode diffusion layer.

### CROSS-REFERENCE TO RELATED APPLICATION

This application claims the benefit of Korean Patent Application No. 10-2007-0016197, filed on Feb. 15, 2007, in the Korean Intellectual Property Office, the disclosure of which is incorporated herein by reference.

### BACKGROUND

1. Technical Field

The present disclosure relates to a fuel cell, and more particularly to a small, portable fuel cell and a membrane electrode assembly used therein.

2. Discussion of Related Art

Since a fuel cell is a pollution-free power supply apparatus, it has been spotlighted as a next-generation clean-energy power generation systems. Uses for fuel cells include on-site generators for large buildings, power supplies for electric vehicles, portable power supplies, and the like, and can use various fuels such as natural gas, city gas, naphtha, methanol, waste gas, and the like. Fuel cells are classified into phosphoric acid fuel cells, alkaline fuel cells, polymer electrolyte membrane fuel cells, direct methanol fuel cells, and solid oxide fuel cells, according to the type of electrolyte used in the fuel cell.

Because polymer electrolyte membrane fuel cells (PEMFC) use polymer membrane electrolytes, there is no risk of corrosion from or evaporation of the electrolyte. PEMFCs can have high current densities per unit area. Moreover, since the polymer electrolyte membrane fuel cell exhibits both very high electrical output and low operating temperature compared with the other types of fuel cells, it has been actively developed as a portable power supply vehicles, a distributed power supply houses, public buildings, and the like, and a compact power supply for electronic equipment and the like.

Since the direct methanol fuel cell (DMFC), which is another fuel cell using a polymer membrane as electrolyte, directly uses liquid-phase fuel, such as methanol, and the like, without the need for a fuel reformer, and has an operating temperature less than about 100° C., it is suitable as a portable power supply or a small power supply.

Current trends in portable electronic equipment such as notebook computers, portable multimedia players (PMP), personal digital assistants (PDA), cellular phones, and the like, are towards increased miniaturization and functionality, thereby driving further miniaturization and higher outputs of polymer electrolyte membrane fuel cells or the direct methanol fuel cells used as a power supplies therefore

### SUMMARY OF THE INVENTION

Therefore, it is an object to provide a small portable fuel cell and a membrane electrode assembly used therein. One aspect provides a fuel cell including: a fuel cell body and a fuel supplier supplying fuel to the fuel cell body, wherein the fuel cell body includes a membrane electrode assembly comprising an ion exchange membrane, an anode catalyst layer positioned at one surface of the ion exchange membrane, an anode gas diffusion layer positioned at one surface of the anode catalyst layer, and a cathode catalyst layer positioned at other surface of the ion exchange membrane; and a bipolar plate comprising a fuel flow field positioned at the one surface of the anode gas diffusion layer, the fuel flow field for supplying the fuel to the anode catalyst layer through the anode diffusion layer.

Another aspect provides a membrane electrode assembly including: an ion exchange membrane; an anode catalyst layer positioned at one surface of the ion exchange membrane; an anode gas diffusion layer positioned at one surface of the anode catalyst layer; and a cathode catalyst layer positioned at other surface of the ion exchange membrane and having thicker thickness than that of the anode catalyst layer.

Another aspect provides a membrane electrode assembly including: an ion exchange membrane; an anode catalyst layer positioned at one surface of the ion exchange membrane; an anode gas diffusion layer positioned at one surface of the anode catalyst layer; and a cathode catalyst layer positioned at other surface of the ion exchange membrane and having lager compression rate than that of the anode catalyst layer.

A further aspect provides a membrane electrode assembly including: an ion exchange membrane; an anode catalyst layer positioned at one surface of the ion exchange membrane; an anode gas diffusion layer positioned at one surface of the anode catalyst layer; and a cathode catalyst layer positioned at other surface of the ion exchange membrane and having a conductive enhancement material.

Some embodiments provide a fuel cell comprising: a fuel cell body; and a fuel system fluidly connected to the fuel cell body. The fuel cell body comprises: a membrane electrode assembly comprising an ion exchange membrane, an anode catalyst layer disposed on a first surface of the ion exchange membrane, an anode gas diffusion layer contacting the anode catalyst layer, and a cathode catalyst layer disposed on a second surface of the ion exchange membrane; and a first monopolar plate disposed on the anode gas diffusion layer, comprising a fuel flow field fluidly contacting the anode gas diffusion layer.

In some embodiments, the fuel cell body further comprises a second monopolar plate contacting a portion of the cathode catalyst layer and exposing a portion of the cathode catalyst layer. In some embodiments, the second monopolar plate comprises a carbon body and a plurality of gas access apertures therethrough.

In some embodiments, the fuel cell body further comprises a second monopolar plate contacting a surface of the cathode catalyst layer, wherein the second monopolar plate has a net form, thereby exposing the cathode catalyst layer.

In some embodiments, the cathode catalyst layer comprises a conductive enhancement structure. In some embodiments, the conductive enhancement structure comprises a conductive metal line embedded into the cathode catalyst layer. In some embodiments, the conductive enhancement structure comprises a conductive metal line in a net form embedded into the cathode catalyst layer.

In some embodiments, the cathode catalyst layer is thicker than the anode catalyst layer. In some embodiments, the cathode catalyst layer and the anode catalyst layer have about the same thickness, and the cathode catalyst layer has a higher compression rate than the anode catalyst layer. In some embodiments, the cathode catalyst layer comprises carbon powder and platinum.

Some embodiments provide a membrane electrode assembly comprising: an ion exchange membrane comprising a first surface and a second surface; an anode catalyst layer disposed on the first surface of the ion exchange membrane; an anode gas diffusion layer contacting the anode catalyst layer; and a cathode catalyst layer disposed on the second surface of the ion exchange membrane, wherein the cathode catalyst layer is thicker thickness than the anode catalyst layer.

In some embodiments, the cathode catalyst layer has a higher compression rate than the anode catalyst layer.

Some embodiments provide a membrane electrode assembly comprising: an ion exchange membrane comprising a first surface and a second surface; an anode catalyst layer disposed on the first surface of the ion exchange membrane; an anode gas diffusion layer contacting a surface of the anode catalyst layer; and a cathode catalyst layer disposed on the second surface of the ion exchange membrane, wherein the cathode catalyst layer has a higher compression rate than the anode catalyst layer.

Some embodiments provide a membrane electrode assembly comprising: an ion exchange membrane comprising a first surface and a second surface; an anode catalyst layer disposed on the first surface of the ion exchange membrane; an anode gas diffusion layer contacting a surface of the anode catalyst layer; and a cathode catalyst layer disposed on the second surface of the ion exchange membrane, and comprising a conductive enhancement structure.

In some embodiments, the cathode catalyst layer comprises carbon powder and platinum.

In some embodiments, the conductive enhancement structure comprises a conductive metal line embedded in the carbon powder. In some embodiments, the cathode catalyst layer comprises platinum nanoparticles distributed in carbon nanotubes. In some embodiments, the conductive enhancement structure is embedded between the carbon nanotubes and comprises a conductive metal net.

In some embodiments, the cathode catalyst layer is thicker than the anode catalyst layer. In some embodiments, the cathode catalyst layer has a higher compression rate than the anode catalyst layer.

### BRIEF DESCRIPTION OF THE DRAWINGS

These and/or other aspects and advantages will become apparent and more readily appreciated from the following description of certain preferred embodiments, taken in conjunction with the accompanying drawings of which:

FIG. 1 is a schematic cross-sectional view of a membrane electrode assembly according to a first embodiment;

FIG. 2 is a schematic cross-sectional view of a membrane electrode assembly according to a second embodiment;

FIG. 3A is a schematic cross-sectional view of a membrane electrode assembly according to a third embodiment;

FIG. 3B is a schematic front view showing a modified example of the membrane electrode assembly according to the third embodiment;

FIG. 4 is a perspective view of a fuel cell body comprising the membrane electrode assembly according to the second embodiment;

FIG. 5 is a perspective view of a fuel cell body comprising the membrane electrode assembly according to the third embodiment;

FIG. 6 is a schematic cross-sectional view of a fuel cell body according to a fourth embodiment;

FIG. 7 is a block diagram of an embodiment of a fuel cell system;

FIG. 8 is a block diagram of another embodiment of a fuel cell system; and

FIG. 9 is a graph showing current-voltage characteristics of an embodiment of a fuel cell.

### DETAILED DESCRIPTION OF CERTAIN EXEMPLARY EMBODIMENTS

Hereinafter, certain exemplary embodiments will be described with reference to the accompanying drawings. Here, when a first element is described as being coupled to a second element, the first element may be not only directly coupled to the second element, but may also be indirectly coupled to the second element through one or more third elements. Furthermore, nonessential elements are omitted for clarity. Also, like reference numerals refer to like elements throughout.

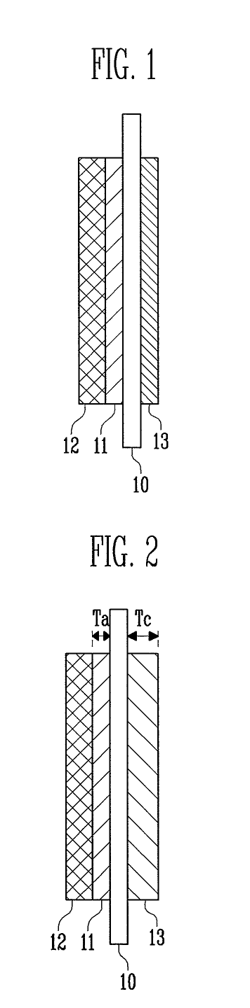

FIG. 1 is a schematic cross-sectional view of a membrane electrode assembly according to a first embodiment. Referring to FIG. 1, the membrane electrode assembly (MEA) includes an ion exchange membrane 10, an anode catalyst layer 11, an anode gas diffusion layer 12, and a cathode catalyst layer 13, wherein the compression rate of the cathode catalyst layer 13 is larger than that of the anode catalyst layer 11.

The membrane electrode assembly of the present embodiment allows the cathode electrode to be formed with only the catalyst layer and without a cathode gas diffusion layer. Accordingly, the amount of oxygen supplied to the cathode electrode is increased by natural convection. In this case, since an expected reduction in a current collection effect of the cathode electrode is compensated by increasing the compression rate of the cathode catalyst layer 13. Accordingly, some embodiments of the MEA exhibit reduced volume, increased output from increased air access thereto, and reduced manufacturing costs.

The ion exchange membrane 10 includes a polymer electrolyte membrane. The polymer electrolyte membrane comprises a solid polymer electrolyte with a thickness of from about 50 μm to 200 μm. The polymer electrolyte membrane functions as an ion transport layer, allowing protons generated at the anode catalyst layer 11 to migrate to the cathode catalyst layer 13.

The anode catalyst layer 11 catalyzes the electrochemical oxidation of hydrogen in the fuel.

The anode gas diffusion layer 12, which backs the anode catalyst layer 11, permits fuel to diffuse therethrough to the anode catalyst layer 11, and collects electrons generated at the anode catalyst layer 11. The anode gas diffusion layer 12 can comprise carbon fiber, carbon paper, and the like.

The cathode catalyst layer 13 catalyzes the reduction of atmospheric oxygen.

The membrane electrode assembly of the present embodiment is manufactured by bonding an anode electrode, on which the anode catalyst layer 11 and the anode gas diffusion layer 12 are stacked, to a first surface of the ion exchange membrane 10, and bonding a cathode electrode, which comprises the cathode catalyst layer 13, to a second surface of the ion exchange membrane 10. The compression rate of the cathode catalyst layer 13 may optionally be selected to increase the conductivity thereof.

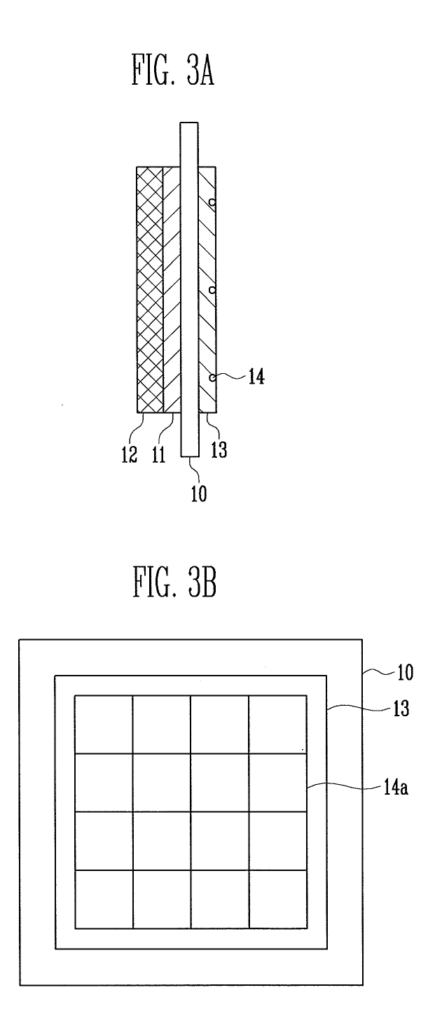

FIG. 2 is a schematic cross-sectional view of a membrane electrode assembly according to a second embodiment. Referring to FIG. 2, the membrane electrode assembly (MEA) includes an ion exchange membrane 10, an anode catalyst layer 11, an anode gas diffusion layer 12, a the cathode catalyst layer 13, wherein a thickness Tc of the cathode catalyst layer 13 is greater than a thickness Ta of the anode catalyst layer 11.

The membrane electrode assembly of the present embodiment allows a cathode electrode to comprise only a catalyst layer without a cathode gas diffusion layer, thereby increasing the amount of oxygen supplied to the cathode electrode by means of natural convection. In some embodiments, increasing the thickness of the cathode catalyst layer 13 compensates for a decrease in current collection at the cathode electrode. Accordingly, both the volume and manufacturing cost of the membrane electrode assembly is reduced, while the supply of air to the cathode is increased, thereby improving the output of the MEA.

As discussed above, the ion exchange membrane 10 comprises a suitable proton conductive solid polymer electrolyte, for example, fluorinated polymers, polyketones, polybenzimidazolics, polyesters, polyamides, polyimides, polysulfones, polystyrenes, hydrocarbon polymers, combinations, and the like. In some embodiments, the solid polymer electrolyte comprises a sulfonated and/or carboxylated perfluorocarbon polymer or copolymer, for example, Nafion® (Dupont). Non-limiting examples of suitable proton conductive polymers include poly(perfluorosulfonic acid), poly(perfluorocarboxylic acid), fluorovinylether/tetrafluoroethylene copolymer sulfonic acid, perfluorinated sulfide polyetherketone, poly(2,2′-(m-phenylene)-5,5′-bibenzimidazole), poly(2,5-benzimidazole), polyimide, polysulfone, polystyrene, polyphenylene, combinations, and the like. The proton conductive polymer may comprise a nanocomposite and acid doped polybenzimidazole with a reaction temperature of about from 150° C. to about 200° C. as the main component.

Solvent may be used in manufacturing the polymer electrolyte membrane. In some embodiments, the solvent includes at least one of an alcohol, such as ethanol, isopropyl alcohol, n-propyl alcohol, and butyl alcohol; water; dimethylsulfoxide (DMSO), dimethylacetamide (DMAc), and N-methylpyrrolidone (NMP).

Preferably, the anode catalyst layer 11 and the cathode catalyst layer 13 include at least one metal catalyst selected from the group consisting of platinum, ruthenium, osmium, platinum-ruthenium alloy, platinum-osmium alloy, platinum-palladium alloy, and platinum-M alloy, where M is at least one of Ga, Ti, V, Cr, Mn, Fe, Co, Ni, Cu, and Zn. In some embodiments, the catalyst in at least one of the anode catalyst layer 11 and the cathode catalyst layer 13 is impregnated in a carrier. Although any material having suitable conductivity may be used as the carrier, a preferred carrier is carbon.

The membrane electrode assembly of the present embodiment can be manufactured by spray coating the cathode catalyst layer 13 to a predetermined thickness Tc on a first surface of the ion exchange membrane 10. The anode catalyst layer 13 is similarly spray coated to a predetermined thickness Ta on a second surface of the ion exchange membrane 10. The anode gas diffusion layer 12 is then bonded to the anode catalyst layer 11. The thickness Tc of the cathode catalyst layer 13 is optionally greater than the thickness Ta of the anode catalyst layer 11 to compensate for the reduction of in current collection.

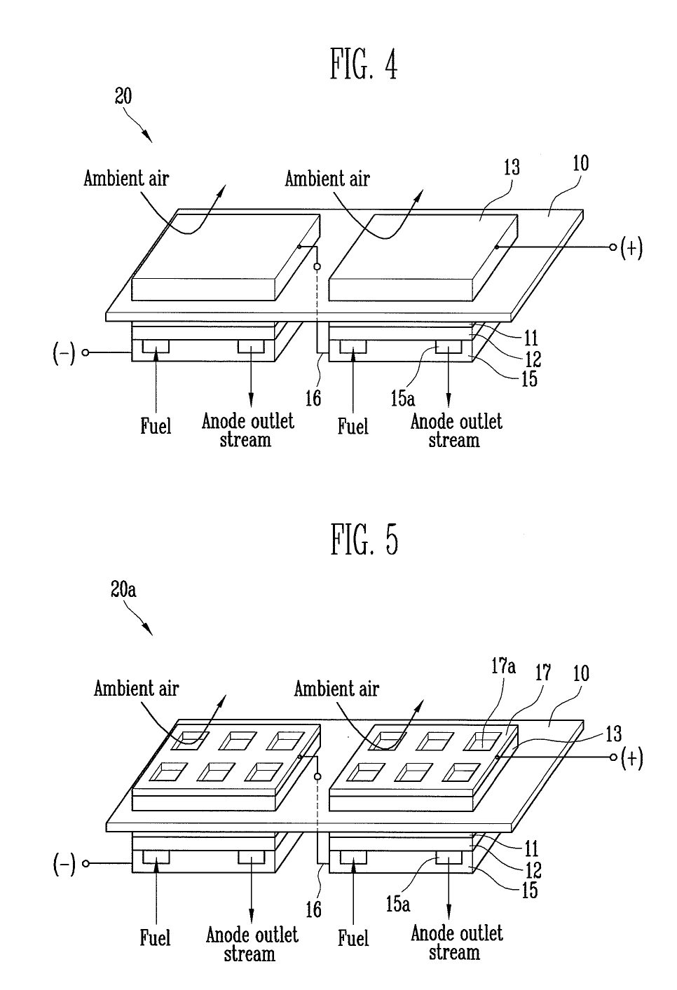

FIG. 3A is a schematic cross-sectional view of a membrane electrode assembly according to a third embodiment. FIG. 3B is a schematic front view of the third embodiment showing a modified example of the membrane electrode assembly. Referring to FIG. 3A, the membrane electrode assembly MEA includes an ion exchange membrane 10, an anode catalyst layer 11, an anode gas diffusion layer 12, a cathode catalyst layer 13, and conductive enhancement structure 14 embedded in the cathode catalyst layer 13, wherein of the cathode catalyst layer 13 has a higher compression rate than the anode catalyst layer 11.

The cathode electrode in the illustrated embodiment comprises a catalyst layer, but does not comprise a cathode gas diffusion layer, thereby increasing the amount of oxygen supplied to the cathode electrode by means of natural convection. In some embodiments, reduction in current collection at the cathode electrode is compensated by the highly-conductive conductive enhancement structure 14 embedded in the cathode catalyst layer 13 as well as the increased compression rate of the cathode catalyst layer 13. According, the volume of the membrane electrode assembly is decreased and the supply amount of air at the cathode is increased, thereby improving the output of the MEA.

The conductive enhancement structure 14 improves the current collection of the cathode catalyst layer 13. In embodiments in which the conductive enhancement structure 14 comprises a metal line structure, the line has any suitable thickness such as an atom-scale diameter, a nanoscale diameter, or the like. Preferably, the metal line has a thickness and length that does not substantially reduce an active area of the cathode catalyst layer 13.

Also, it is preferable that the conductive enhancement structure 14 comprises a metal used in the cathode catalyst layer 13, for example, at least one of platinum, ruthenium, osmium, platinum-ruthenium alloy, platinum-osmium alloy, platinum-palladium alloy, and platinum-M alloy, where M is at least one of Ga, Ti, V, Cr, Mn, Fe, Co, Ni, Cu, and Zn.

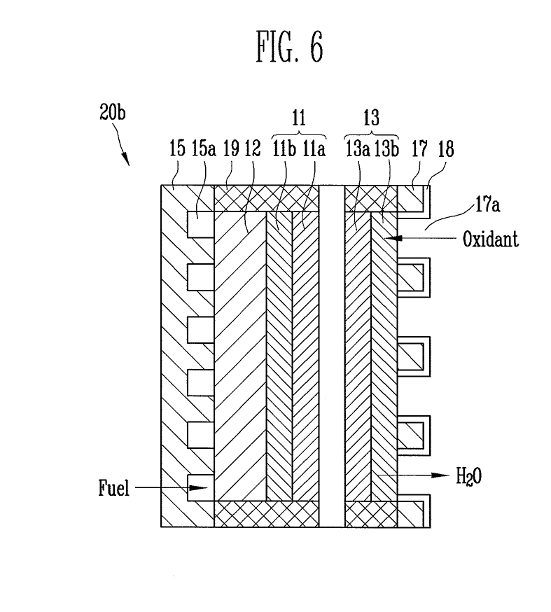

Also, the conductive enhancement structure 14 can comprise at least one metal lines formed in a straight line, a curved line, or a grid. In particular, as shown in FIG. 3B, the conductive enhancement structure 14a can be disposed between the cathode catalyst layer 13 and a current collector (for example, 17 in FIG. 5), which backs the cathode catalyst layer 13. In the illustrated embodiment, the conductive enhancement structure 14a has a net or grid form.

FIG. 4 is a perspective view of an embodiment of a fuel cell body 20 comprising a membrane electrode assembly according to the second embodiment. Referring to FIG. 4, the fuel cell body 20 includes two single cells electrically connected to each other in series by means of an inner wiring 16, wherein each single cell includes an ion exchange membrane 10, an anode catalyst layer 11, an anode gas diffusion layer 12, a cathode catalyst layer 13, and a current collector 15. An oxidant supplied to the cathode electrode in the fuel cell body 20 of the present embodiment is oxygen in ambient air.

The current collector 15 backing the anode gas diffusion layer 12 is referred to as a monopolar plate or a separator. The current collector 15 includes a fuel flow field 15a for transferring fuel to the anode catalyst layer 11 through the anode gas diffusion layer 12. The dimensions and shape of the fuel flow field 15a are selected according to factors including the type of fuel, type of fuel manifold, size of the membrane electrode assembly, and the like.

The current collector 15 comprises any suitable nonporous material, which prevents fuel leaks; sufficient electrical conductivity; sufficient heat conductivity, sufficient mechanical strength, and acid corrosion-resistance, for example, stainless steel.

FIG. 5 is a perspective view of an embodiment of a fuel cell body 20a comprising a membrane electrode assembly according to the third embodiment. Referring to FIG. 5, the fuel cell body 20a includes two single cells electrically connected to each other in series by means of an inner wiring 16, wherein each single cell includes an ion exchange membrane 10, an anode catalyst layer 11, an anode gas diffusion layer 12, a cathode catalyst layer 13, a first current collector 15, and a second current collector 17. An oxidant supplied to the cathode electrode in the fuel cell body 20 of the present embodiment is oxygen in air by means of natural convection.

As discussed above, the cathode catalyst layer 13 comprises a metal conductor for improving current collection. In this case, the metal conductor preferably has a net or grid shape corresponding to the net or grid shape of the second current collector 17, thereby increasing contact therebetween.

The first current collector 15 includes a fuel flow field 15a, contacting the anode gas diffusion layer 12, through which fuel is supplied to the anode catalyst layer 11.

The second collector 17 includes a plurality of apertures 17a through which an oxidant contacts the cathode catalyst layer 13. The second current collector 17a collects electrons generated at the cathode catalyst layer 13.

Those skilled in the art will understand that in other embodiments, the fuel cell body comprises three or more single cells, thereby providing a fuel cell with the desired current-voltage characteristics.

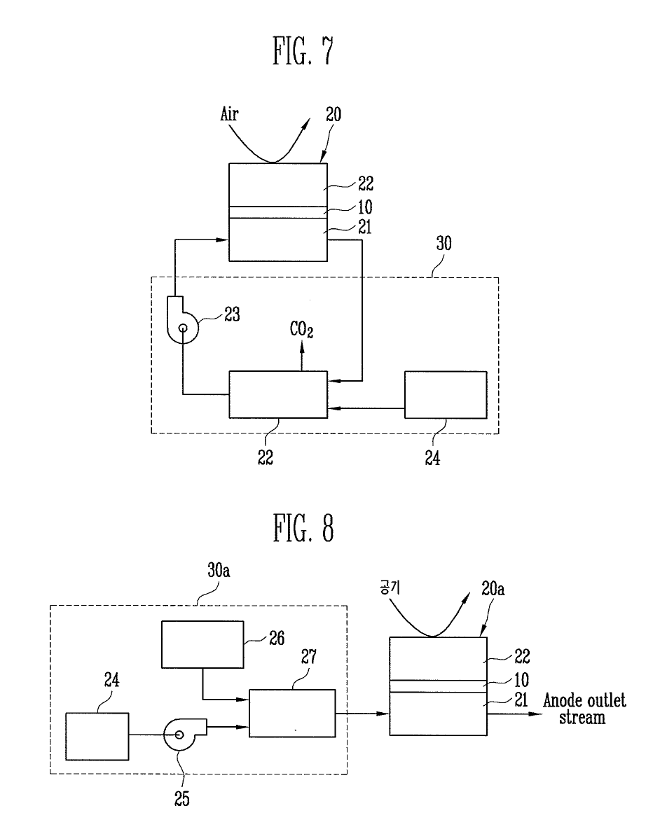

FIG. 6 is a schematic cross-sectional view of a fuel cell body 20b according to a fourth embodiment. Referring to FIG. 6, the fuel cell body includes an ion exchange membrane 10, an anode catalyst layer 11, an anode gas diffusion layer 12, a cathode catalyst layer 13, a first current collector 15, a second current collector 17, a moisture removing layer 18, and a gasket 19.

The anode catalyst layer 11 includes a first anode catalyst layer 11a and a second anode catalyst layer 11b. In some embodiments, the first anode catalyst layer 11a is manufactured by a wet coating method and comprises a metal catalyst and a nanocarbon as a catalyst layer contacting the gas diffusion layer 12 or the polymer electrolyte membrane 10. The second anode catalyst layer 11b is formed on one side of the first anode catalyst layer 11a by sputtering. The first anode catalyst layer 11a maximizes the surface area of the catalyst therein. The second anode catalyst layer 11b improves contact between the first anode catalyst layer 11a, and the gas diffusion layer 12 or polymer electrolyte membrane 10, thereby improving the output of the fuel cell.

The anode gas diffusion layer 12 comprises a microporous layer and a backing layer. The microporous layer uniformly distributes the fuel to the anode catalyst layer 11. The microporous layer as described above can comprise a carbon layer coated on the backing layer, where the carbon layer preferably comprises at least one of graphite, carbon nanotubes (CNT), fullerene (C₆₀ and/or C₇₀), activated carbon, carbon black (Vulcan®, Cabot Corp.), ketjen black, and carbon nano horns. Also, the microporous layer may further include at least one binder selected from the group consisting of poly(perfluorosulfonic acid), poly(tetrafluoroethylene), and fluorinated ethylene-propylene.

The backing layer distributes fuel, water, air, and the like, collects the electricity generated, and prevents material loss from the anode catalyst layer 11 while backing each electrode. The backing layer as described above can comprise a carbon substrate such as carbon cloth, carbon paper, and the like.

The first current collector 15 includes a fuel flow field 15a contacting the anode gas diffusion layer 12, and through which fuel is supplied to the anode catalyst layer 11.

The second current collector 17 contacts the cathode catalyst layer 13, and comprises a plurality of apertures 17a through which oxidant is supplied to the cathode catalyst layer 13.

The embodiments described above do not include a cathode gas diffusion layer. Instead, the microporous layer of the cathode gas diffusion layer smoothly discharges water generated from the cathode catalyst layer 13. In some embodiments, however, water may not be smoothly discharged from the cathode catalyst layer 13.

Accordingly, the fuel cell body 20b comprises a moisture removing layer 18 disposed on an exposed surface of the second current collector 17, and contacting the cathode catalyst layer 13 through the apertures 17a. The moisture removing layer 18 removes moisture by absorbing the water from the cathode electrode 13. The moisture removing layer 18 has a predetermined thickness on the outer surface of the second current collector 17, and contacts the exposed surface of the cathode catalyst layer 13 through the apertures 17a of the second collector 17. The thickness of the moisture removing layer 18 is optionally selected according to the amount of water generated at the second cathode catalyst layer 13.

The moisture removing layer 18 as described above can comprise a mixture of a moisture absorption material and a piezoelectric polymer. As the moisture absorption material, silica (SiO₂) and materials in which silica is the main component can be used. The piezoelectric polymer forms a coating layer that stably attaches the moisture absorption material to the inner surfaces of the apertures 17a of the second current collector 17. The piezoelectric polymer comprises a fluoro resin such as polyvinylidene fluoride (PVDF), and the like, or a resin-based material in which the fluoro resin is the main component. A solvent can be used to dissolve the piezoelectric polymer, which is then mixed with the moisture absorption material. Suitable solvents include acetone, and the like.

The moisture removing layer 18 as described above can be formed as follows. First, a slurry is produced by thoroughly mixing silica, PVDF, and acetone, then spray coating the slurry onto the exposed surfaces of the second current collector 17 and the inner surfaces of the apertures 17a.

The fuel cell body 20b can further include the gasket 19. The gasket 19 prevents leaking of the fuel and oxidant supplied to the anode electrode and the cathode electrode. The gasket 19 may be integrally and/or separately manufactured with the first and second current collectors 15 and 17. Also, the gasket 19 can comprise an elastic member, for example comprising rubber, silicone, and the like; or take the form of a metal plate.

FIG. 7 is a block view of an embodiment of a fuel cell . Referring to FIG. 7, the fuel cell includes a fuel cell body 20 and a fuel system 30. The fuel cell body 20 includes an anode region 21 and a cathode region 22 formed on either side of a polymer electrolyte membrane 10. The fuel system 30 includes a circulation tank 22 in which unreacted fuel from the anode region 21 of the fuel cell body 20 is recovered, a fuel tank 24 in which liquid-phase raw fuel is stored and supplied to the circulation tank 22, and an injection pump 23 for supplying a fuel mixture stored in the circulation tank 22 to the anode region of the fuel cell body 20. The fuel cell body 20 is described in detail above.

The fuel cell according to the present embodiment can be a direct methanol fuel cell, which generates electricity by electrochemically oxidizing hydrogen contained in the liquid-phase methanol fuel directly injected into the anode region 21, with oxygen from the air supplied to the cathode region 22 by natural convection.

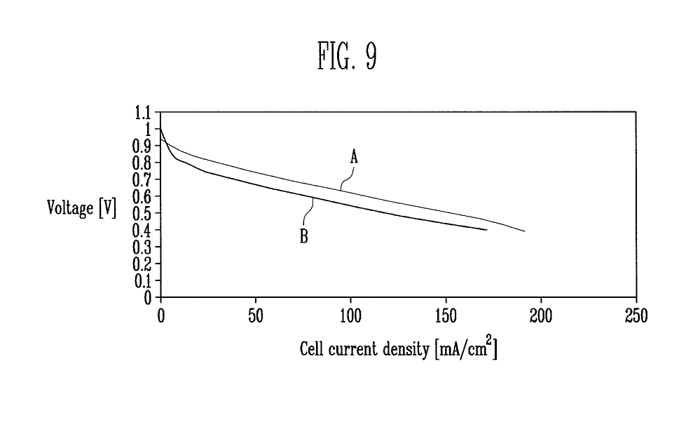

FIG. 8 is a block view of another embodiment of a fuel cell. Referring to FIG. 8, the fuel cell includes a fuel cell body 20a and a fuel system 30a. The fuel cell body 20a includes an anode region 21 and a cathode region 22 formed either side of the polymer electrolyte membrane 10. The fuel cell system 30a includes a fuel tank 24 in which a liquid-phase and/or a gas-phase fuel is stored, a pump 25 supplying the fuel from the fuel tank 24 to a reformer 27, a water reservoir 26 fluidly connected to the reformer 27, and a reformer 27, in which the fuel is reformed into hydrogen by a reaction of fuel and water. The fuel cell body 20a is described in detail above.

The fuel cell according to the present embodiment can comprise a polymer electrolyte fuel cell generating electricity from hydrogen contained in the reformer gas supplied to the anode region 21 and oxygen in air supplied to the cathode region 22 by natural convection.

FIG. 9 is a graph showing current-voltage characteristics of an embodiment of a fuel cell. This experiment compares the current-voltage characteristics between a fuel cell comprising a one membrane electrode assembly with an anode gas diffusion layer, but without a cathode gas diffusion layer (A, FIG. 1), and a fuel cell comprising a one membrane electrode assembly comprising both an anode gas diffusion layer and a cathode gas diffusion layer (B). As shown in FIG. 9, the current-voltage characteristics of the fuel cell A are better than that of the fuel cell B.

Although certain embodiments have been shown and described in detail, it would be appreciated by those skilled in the art that changes might be made in these embodiments without departing from the principles and spirit of the disclosure, the scope of which is defined in the claims and their equivalents.

What is claimed is:

1. A fuel cell comprising:
a fuel cell body; and
a fuel system fluidly connected to the fuel cell body, wherein the fuel cell body comprises:
a membrane electrode assembly comprising an ion exchange membrane, an anode catalyst layer disposed on a first surface of the ion exchange membrane, an anode gas diffusion layer contacting the anode catalyst layer, and a cathode catalyst layer disposed on a second surface of the ion exchange membrane; and
a first monopolar plate disposed on the anode gas diffusion layer, comprising a fuel flow field fluidly contacting the anode gas diffusion layer.

2. The fuel cell as claimed in claim 1, wherein the fuel cell body further comprises a second monopolar plate contacting a portion of the cathode catalyst layer and exposing a portion of the cathode catalyst layer.

3. The fuel cell as claimed in claim 2, wherein the second monopolar plate comprises a carbon body and a plurality of gas access apertures therethrough.

4. The fuel cell as claimed in claim 1, wherein the fuel cell body further comprises a second monopolar plate contacting a surface of the cathode catalyst layer, wherein the second monopolar plate has a net form, thereby exposing the cathode catalyst layer.

5. The fuel cell as claimed in claim 1, wherein the cathode catalyst layer comprises a conductive enhancement structure.

6. The fuel cell as claimed in claim 5, wherein the conductive enhancement structure comprises a conductive metal line embedded into the cathode catalyst layer.

7. The fuel cell as claimed in claim 5, wherein the conductive enhancement structure comprises a conductive metal line in a net form embedded into the cathode catalyst layer.

8. The fuel cell as claimed in claim 1, wherein the cathode catalyst layer is thicker than the anode catalyst layer.

9. The fuel cell as claimed in claim 1, wherein the cathode catalyst layer and the anode catalyst layer have about the same thickness, and the cathode catalyst layer has a higher compression rate than the anode catalyst layer.

10. The fuel cell as claimed in claim 1, wherein the cathode catalyst layer comprises carbon powder and platinum.

11. A membrane electrode assembly comprising:
an ion exchange membrane comprising a first surface and a second surface;
an anode catalyst layer disposed on the first surface of the ion exchange membrane;
an anode gas diffusion layer contacting the anode catalyst layer; and
a cathode catalyst layer disposed on the second surface of the ion exchange membrane, wherein the cathode catalyst layer is thicker thickness than the anode catalyst layer.

12. The membrane electrode assembly as claimed in claim 11, wherein the cathode catalyst layer has a higher compression rate than the anode catalyst layer.

13. A membrane electrode assembly comprising:
an ion exchange membrane comprising a first surface and a second surface;
an anode catalyst layer disposed on the first surface of the ion exchange membrane;
an anode gas diffusion layer contacting a surface of the anode catalyst layer; and
a cathode catalyst layer disposed on the second surface of the ion exchange membrane, wherein the cathode catalyst layer has a higher compression rate than the anode catalyst layer.

14. A membrane electrode assembly comprising:
an ion exchange membrane comprising a first surface and a second surface;
an anode catalyst layer disposed on the first surface of the ion exchange membrane;
an anode gas diffusion layer contacting a surface of the anode catalyst layer; and
a cathode catalyst layer disposed on the second surface of the ion exchange membrane, and comprising a conductive enhancement structure.

15. The membrane electrode assembly as claimed in claim 14, wherein the cathode catalyst layer comprises carbon powder and platinum.

16. The membrane electrode assembly as claimed in claim 15, wherein the conductive enhancement structure comprises a conductive metal line embedded in the carbon powder.

17. The membrane electrode assembly as claimed in claim 14, wherein the cathode catalyst layer comprises platinum nanoparticles distributed in carbon nanotubes.

18. The membrane electrode assembly as claimed in claim 17, wherein the conductive enhancement structure is embedded between the carbon nanotubes and comprises a conductive metal net.

19. The membrane electrode assembly as claimed in claim 14, wherein the cathode catalyst layer is thicker than the anode catalyst layer.

20. The membrane electrode assembly as claimed in claim 14, wherein the cathode catalyst layer has a higher compression rate than the anode catalyst layer.
